(19) United States
(12) Patent Application Publication
(10) Pub. No.: US 2026/0002082 A1
(43) Pub. Date: Jan. 1, 2026

(54) REMOVAL OF SILICONES AND OTHER IMPURITIES IN PYROLYSIS OIL USING SILICA GEL MATRICES

(71) Applicant: SABIC Global Technologies B.V., Bergen op Zoom (NL)

(72) Inventors: Anupam GIRI, Bergen op Zoom (NL); Omid EMAMJOMEH, Bergen op Zoom (NL); Fabrice CUOQ, Geleen (NL); Kae Shin WONG, Geleen (NL)

(73) Assignee: SABIC Global Technologies B.V., Bergen op Zoom (NL)

(21) Appl. No.: 19/116,039

(22) PCT Filed: Oct. 10, 2023
(86) PCT No.: PCT/IB2023/060186

§ 371 Date: Mar. 27, 2025

(30) Foreign Application Priority Data
Oct. 13, 2022 (EP) 22201371.6

(51) Int. Cl. C10G 25/00; B01D 15/20; B01J 20/10; B01J 20/28; B01J 20/34

(52) U.S. Cl. CPC C10G 25/003; B01D 15/203; B01J 20/103; B01J 20/28016; B01J 20/28085; B01J 20/3433; C10G 2300/1003; C10G 2300/202

(57) ABSTRACT

A process to reduce siloxanes in a waste plastic pyrolysis oil composition is disclosed. The process can include contacting the waste plastic pyrolysis oil composition with a modified silica gel composition under conditions sufficient to produce a purified waste plastic pyrolysis oil composition. The purified waste plastic pyrolysis oil composition can have at least 50% by weight less siloxanes, preferably at least 60% by weight less siloxanes, as compared to the untreated waste plastic pyrolysis oil composition. The siloxanes can include acyclic siloxanes, cyclic siloxanes, or a combination thereof. The modified silica gel composition can include cobalt or iron compositions.

### CROSS REFERENCE TO RELATED APPLICATION

This application claims the benefit of priority of European Patent Application No. 22201371.6, filed Oct. 13, 2022, which is hereby incorporated by reference in its entirety.

### TECHNICAL FIELD

The present invention generally relates to systems and methods of processing pyrolysis oil (pyoil). More specifically, the present invention relates to system and methods for pre-treating waste plastic pyoil with a silica gel to reduce siloxane content in the pyoil. This can help create a more stable pyoil product and/or a more desirable pyoil raw material for cracking.

### BACKGROUND ART

Plastics are found in industrial and domestic applications. While tons of plastics are produced every day, waste plastics have created serious environmental challenges due to their extremely long natural decomposition process. Thus, various processes for reuse and/or recycle plastics have been explored in the last few decades.

Pyrolysis of waste mixed plastics is a process that includes decomposing plastics at a high temperature to produce a pyoil. Pyoil can be used directly as a liquid fuel or further processed for producing chemicals of high value. However, pyoil produced from mixed plastics generally contains a substantial amount of highly reactive chemicals, resulting in fast aging of the pyoil and formation of gums during transportation and further processing steps. Hence, it is fairly common for pyoil to foul containers and/or chemical processing units in which it is handled and/or processed with trace oxygen presented therein.

Methods to reduce contaminants in processing of waste mixed plastics have been described. For example, International Application Publication No. WO 2021/255591 to Giri et al., describes absorbent systems to trap and/or adsorb gum and/or gum precursors and other heteroatom containing components. The absorbent system can include activated charcoal (carbon), a molecular sieve, a bleaching clay, a silica hydrogel, an ionic resin, a cured eggshell powder, or a combination thereof.

Overall, while systems and methods for treating waste plastic pyoil derived from mixed plastics exist, the need for improvements in this field persists.

### SUMMARY OF THE INVENTION

A discovery has been made that provides a solution to at least one of the aforementioned problems associated with the systems and methods of purifying waste plastic pyrolysis oil. In one aspect, the invention can include a process to reduce siloxanes (e.g., acyclic siloxanes, cyclic siloxanes, or a combination thereof) in waste plastic pyrolysis oil compositions. The process can include treating the waste plastic pyrolysis oil composition with a modified silica gel composition, which can reduce the amount of siloxanes in the treated composition compared with an untreated composition. In certain aspects, the treated composition can include at least 50 wt. % or at least 60 wt. % less siloxanes when compared with an untreated composition. The processes of the present invention can also reduce or eliminate other components from the pyrolysis oil compositions (e.g., heteroatom-containing components (e.g., oxygen-containing, organic nitrogen-containing, chloro-containing, in the waste plastic pyrolysis oil)). Siloxanes and/or the other components present in waste plastic pyrolysis oil can reduce catalyst life, reduce corrosion, limit NOx formation, and reduce fouling when processing waste plastic pyrolysis oil. Accordingly, the invention provides a simple, cost effective process for reducing siloxanes and other components from waste plastic pyrolysis oil. This makes the storing of, transportation of, and/or processing of the treated waste plastic pyrolysis oil of the present invention more efficient and less detrimental to the equipment, components, and catalyst compositions used to store, transport, and/or process the pyoil.

In one aspect of the present invention, processes to reduce siloxanes in a waste plastic pyrolysis oil are described. A process can include contacting an unpurified or untreated waste plastic pyrolysis oil composition with a modified silica gel composition under conditions sufficient to produce a purified or treated waste plastic pyrolysis oil composition having at least 50% or at least 60% by weight less siloxanes when compared to the unpurified or untreated waste plastic pyrolysis oil composition. The siloxanes can include acyclic siloxanes, cyclic siloxanes, or a combination thereof. The modified silica gel composition can include cobalt (e.g., CoCl₂) and/or iron. The modified silica gel composition can include silica gel particles, granulates, powder, or a combination thereof. In some aspects, the modified silica gel composition is ground. Modified silica gel particles can have a pore diameter of 0.01 mm to 5.0 mm, pore size of 1.5 nm to 7 nm, or a combination thereof. In another aspect, the modified silica gel granulates can have a pore size of 1.5 nm to 5 nm, a pore diameter of 0.5 mm to 5 mm, or a combination thereof. Modified silica gel powder can have pore size of 5 nm to 7 nm, a pore diameter of 0.03 mm to 0.08 mm, or a combination thereof. A weight ratio of the modified silica gel composition to the pyrolysis oil is 0.005 to 1. Contacting conditions can include a temperature of 10° C. to 100° C., a pressure of 0.101 MPa to 1 MPa, a contact rate of 0.1 bed volume per hour (BV/h) to 5 BV/h, or a combination thereof. In some aspects, the modified silica gel composition can include cobalt chloride. Mixtures of unmodified silica gel and silica gel modified with cobalt (e.g., CoCl₂ silica, or iron complexes) can also be used in the process of the present invention. In one preferred aspect, the modified silica gel composition is in a dehydrated form. In a preferred aspect, the modified silica gel can be dehydrated CoCl₂ silica. The modified silica gel composition can be regenerated (e.g., by heating the modified silica gel composition). In addition to siloxanes, the contact of the modified silica gel composition with the waste plastic pyrolysis oil composition can reduce the total level of heteroatom-containing compounds (e.g., by at least 50 wt. %). For example, the process can lower the amount of oxygen-containing compounds by at least 50 wt. % as compared to the same waste plastic pyrolysis oil composition without contact with the modified silica gel composition. The amount of total organic nitrogen-containing compounds can be lowered by at least 50 wt. %, at least 80 wt. %, at least 90 wt. % as compared to the same waste plastic pyrolysis oil composition that has not been treated with the modified silica gel composition. Chloride-containing compounds chloride can be reduced by at least 50 wt. %, at least 60 wt. % as compared to the same waste plastic pyrolysis oil composition that has not been treated with the modified silica gel composition, wherein the chloride compounds comprise inorganic chloride compounds and organic chloride compounds.

The following includes definitions of various terms and phrases used throughout this specification.

The terms “about” or “approximately” are defined as being close to as understood by one of ordinary skill in the art. In one non-limiting embodiment the terms are defined to be within 10%, preferably, within 5%, more preferably, within 1%, and most preferably, within 0.5%.

The terms “wt. %,” “vol. %” or “mol. %” refer to a weight, volume, or molar percentage of a component, respectively, based on the total weight, the total volume, or the total moles of material that includes the component. In a non-limiting example, 10 moles of component in 100 moles of the material is 10 mol. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification, include any measurable decrease or complete inhibition to achieve a desired result.

The term “effective,” as that term is used in the specification and/or claims, means adequate to accomplish a desired, expected, or intended result.

The term “gum,” refers to phased out solid and/or creamy and/or semisolids portion from liquid pyrolysis oil (pyoil). In embodiments of the invention, “gum” can include components having an average molecular weight of 400 Dalton that are soluble or crash out of the solution and/or liquid. Many cracked gasolines, especially those unrefined, a thick resinous material deposited under certain conditions can include gum. For instance, on long standing in dark condition or diffused light condition, it is common that a semi-fluid material, known as “gum,” gradually accumulate as a brown, sticky mass at the bottom of the oil. Another example of “gum” can include that a dark brown, hard, and resinous residue that can be obtained by evaporation of a liquid product including a cracked gasoline and/or pyoil in a copper dish.

The term “stability,” refers to a pyoil composition is not altered over time by chemical reactions. In embodiments of the invention, “stability” can mean that there is limited or no reactivity of pyoil (treated by an adsorbent) due to cleaning/trapping of reactive substances by the adsorbent. As a result, substantially no or no further formation of gum or any other color changes occurred and properties remained unchanged for a longer period of time after purification.]

The use of the words “a” or “an” when used in conjunction with the term “comprising,” “including,” “containing,” or “having” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The processes of the present invention can “comprise,” “consist essentially of,” or “consist of” particular ingredients, components, compositions, etc., disclosed throughout the specification. With respect to the transitional phrase “consisting essentially of,” in one non-limiting aspect, a basic and novel characteristic of the processes of the present invention are their abilities to lower the amount of siloxanes in a waste plastic pyrolysis oil in a cost and energy efficient manner.

The term “primarily,” refers to greater than any of 50 wt. %, 50 mol. %, and 50 vol. %. For example, “primarily” may include 50.1 wt. % to 100 wt. % and all values and ranges there between, 50.1 mol. % to 100 mol. % and all values and ranges there between, or 50.1 vol. % to 100 vol. % and all values and ranges there between.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is an illustration of a schematic diagram of a system for purifying waste plastic pyrolysis oil, according to embodiments of the invention.

FIG. 2 shows visual comparison of untreated and treated pyoil using active charcoal, molecular sieve, and CoCl₂ modified silica gel granulates of the present invention.

FIG. 3 shows X-ray fluorescence data of untreated and treated pyoil using active charcoal, molecular sieve, and CoCl₂ modified silica gel granulates of the present invention.

FIGS. 4A and 4B show 1-H NMR based analysis of Si-species in raw and CoCl₂ modified silica gel treated pyoil.

FIG. 5 shows two dimensional gas chromatograph (GC×GC) contour plots revealing the reduction of oxygenates in pyoil after treatment with the CoCl₂ modified silica gel granulates.

FIGS. 6A, 6B and 6C show visual observation of three different pyoils along with the same pyoils treated by silica gel granulates, silica gel granulate-grinded, and silica gel powder. From left to right FIG. 6A is pyoil 1 untreated (raw), pyoil 1 treated with silica gel granulates with CoCl₂, pyoil 1 treated with CoCl₂ silica gel granulates-grinded, and pyoil 1 treated with silica gel powder; FIG. 6B is pyoil 2 untreated (raw), pyoil 2 treated with CoCl₂ silica gel granulates, pyoil 2 treated with CoCl₂ silica gel granulates-grinded, and pyoil 2 treated with silica gel powder; and FIG. 6C is pyoil 3 untreated (raw), pyoil 3 treated with CoCl₂ silica gel granulates, pyoil 3 treated with CoCl₂ silica gel granulates-grinded, and pyoil 3 treated with silica gel powder.

FIG. 7 is a graphical illustration comparing total contents of Si—, Cl—, and TON for untreated pyoils, and the same pyoils treated by silica gel granulates, silica gel granulate-grinded, and silica gel powder.

FIG. 8 shows comparative XRF spectra for elemental-cobalt and chlorine in a CoCl₂ modified silica gel composition of the present invention.

FIG. 9 shows CoCl₂ silica gel (left) and hydrated CoCl₂ silica gel (right).

While the invention is susceptible to various modifications and alternative forms, specific embodiments thereof are shown by way of example in the drawings. The drawings may not be to scale.

### DETAILED DESCRIPTION OF THE INVENTION

Currently, pyoil, especially pyoil derived from pyrolysis of plastics, has a high siloxane content and/or gum or gum precursor content. This can be detrimental to the equipment and materials used to store, transport, and/or process pyoil (e.g., lower catalyst life, high gum formation, low stability of the pyoil, and high acidity of the pyoil). Thus, it is highly challenging to store, transport, and/or process pyoil in a chemical plant. Therefore, pyoil is oftentimes burned for use as fuel in the chemical plant. A discovery has been made that provides at least one solution to at least some of these problems. The method includes contacting waste plastic pyrolysis oil with a modified silica gel composition to remove siloxanes from the pyoil, thereby reducing the compounds that can poison a catalyst, thus reducing the catalyst's life. The process can also remove gum by removing gum precursors. Thus, the stability of the pyoil can be greatly improved for storage, transportation, and/or further processing. The purified pyoil produced by the process of the present invention can be used in a cracking process to produce high value chemicals such as olefins, including light olefins (C2 to C4 olefins), C5+ olefins, and/or aromatics such as benzene, toluene, and xylene.

These and other non-limiting aspects of the present invention are discussed in further detail in the following sections with reference to the Figures.

### A. Modified Silica Gel Composition and Wasted Plastic Pyrolysis Oil

The modified silica gel composition can include CoCl₂ silica gel, iron complexed silica gel, or a mixture thereof. In some embodiments, the modified silica gel is a mixture of unmodified silica and modified silica gel. Silica gel compositions are commercially available (e.g., Sigma-Aldrich® (USA), AGM Container Controls, Inc. (Tucson, AZ, USA), ChemPoint (USA), and the like). The modified silica gel composition can be in the form of particles, granulates, powder, or a mixture thereof. The modified silica gel composition can be ground prior to use. The modified silica gel composition(s) can have a pore diameter and a pore size. A pore diameter of the modified silica gel composition particles can be 0.01 mm to 5.0 mm, or 0.01, 0.05, 0.1, 0.5, 1, 1.5, 2, 2.5, 3, 3.5, 4, 4.5, 5 mm or any range or value there between. A pore size of modified silica gel composition particles can range from 1.5 nm to 7 nm, or 1.5, 2, 2.5, 3, 3.5, 4, 4.5, 5, 5.5, 6, 6.5, 7.0 nm or any range or value there between. Modified silica gel composition granulates can have a pore diameter of 0.5 mm to 5 mm, or 0.5, 1, 1.5, 2, 2.5, 3, 3.5, 4, 4.5, 5 mm or any range or value there between. Pore size of the modified silica gel composition granulates can range from 1.5 nm to 5 nm, or 1.5, 2, 2.5, 3, 3.5, 4, 4.5, 5 mm or any range or value there between. Modified silica gel composition powder can have a pore diameter of 0.03 mm to 0.08 mm, or 0.03, 0.04, 0.05, 0.06, 0.07, 0.08 mm or any range or value there between. A pore size of modified silica gel composition powder can range from 5 nm to 7 nm, or 5, 5.5., 6, 6.5, 7 nm or any value or range thereof. Unmodified silica can include silica gel or silica hydrogels.

The modified silica gel composition can have a surface area in a range of 200 m²/g to 1200 m²/g and all ranges and values there between. For example, 200 m²/g, 300 m²/g, 400 m²/g, 500 m²/g, 600 m²/g, 700 m²/g, 800 m²/g, 900 m²/g, 1000 m²/gm, 1100 m²/g, 1200 m²/g and all ranges and values there between.

The modified silica gel composition can trap, adsorb, and/or remove at least some of, one or more of: (a) acyclic siloxanes, cyclic siloxanes, or a combination thereof, (b) oxygen containing compounds, (c) nitrogen containing compounds, (d) chlorine containing compounds, (e) polynuclear aromatics and heavy tails (C20+), and (f) heavy metals from the waste plastic pyrolysis oil, thereby removing gum and/or gum precursors from the pyoil and increasing stability of the pyoil. In embodiments of the invention, the adsorbent can further remove other heteroatom containing compounds that are not gum or gum precursors. The adsorbent, in embodiments of the invention, can also remove other oxygen containing compounds, nitrogen containing compounds, chlorine containing compounds that are not gum or gum precursors.

Non-limiting examples of acyclic siloxanes include hexamethyldisiloxane, octamethyltrisiloxane, decamethyltetrasiloxane, dodecamethylpentasiloxane, tetradecamethylhexasiloxane and the like. Non-limiting examples of cyclic siloxanes include hexamethylcyclotrisiloxane, octamethylcyclotetrasiloxane, decamethylcyclopentasiloxane, dodecamethylcyclohexasiloxane, and the like.

Non-limiting examples of oxygen and/or nitrogen containing compounds can include aliphatic acids, aromatic acids, nitriles, amines, aldehydes, aliphatic/cyclic ketones, cyclic amides, aliphatic/aromatic alcohols, diols, esters, ethers, aliphatic/cyclic chlorines, furans, indoles, quinolines, phenolic compound, indolic compounds, acidic compounds, alcohols, amines, or combinations thereof. The oxygen and/or nitrogen containing compounds can include 2-heptadecanone, 2-pentanone, caprolactam, 3-heptanol, methyl (iso2), octadecanenitrile, oleanitrile, cyclopentanone, traidecanenitrile, heptanoic acid, doedecanophenone, 2-cyclopentenol, 1-butanol, benzoic acid, hexanenitrile, tridecanenitrile, 2-cyclopenten-1-one, 2-hydroxy-3-m, phenol, C5 substituted (iso2) 2-cyclopenten-1-one, 3-ethyl-2-hydro, or a combination thereof.

Non-limiting examples of chloride containing compounds can include 1,2-dichloroethane, ethanol, 2-chloroacetate, 2, chloroethanol, ethanol, 2-(2-chloroethoxy), benzene, (2-chloroethoxy), or a combination thereof.

Scheme I shows a representation of a proposed mechanism of action to remove siloxanes using a modified silica gel composition of the present invention. At the modified silica gel composition surface, hydrogen bonding (triangles) can occur between Si—O—Si bonds of the siloxane skeleton and silanol groups. This interaction can be about 10 KJ/mol, lower than covalent bonds, but stronger than Van der Waals interactions. Due to the interaction ring opening can occur and linear siloxanes can be formed. The cleavage of the Si—O bonds (waving line) can be enhanced favored in acidic aqueous conditions which are adhered to silica gel. At a higher uptake, polymerization of short linear chains into polydimethylsiloxane can be promoted by the proximity of the molecules.

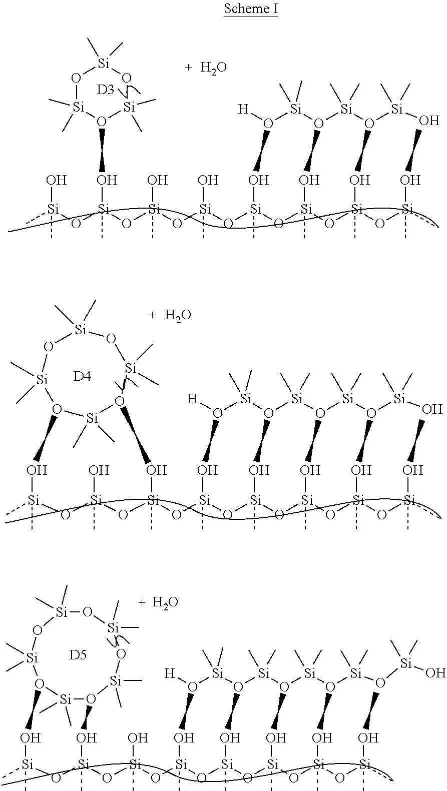

When cobalt chloride is incorporated into the modified silica gel composition, the cobalt chloride can form adducts that are either octahedral or tetrahedral in structure. For example, octahedral complexes can be formed with nitrogen containing compounds and tetrahedral complexes can be formed with phosphorous containing compounds. This is illustrated in reaction (1) for pyridine and reaction (2) for triphenylphosphine. In some instances, nitrogen-containing compounds can form salts of the anionic complex CoCl₄ as shown in reaction (3) using tetraethyl ammonium chloride as an example. CoCl₂ can also chelate with alkyl silanes as illustrated in reaction (4) using trimethylsilyl chloride as an example. Other heteroatom removal can involve hydrogen bonding between the compounds and silanol groups at silica gel surface in presence of small amount of water.

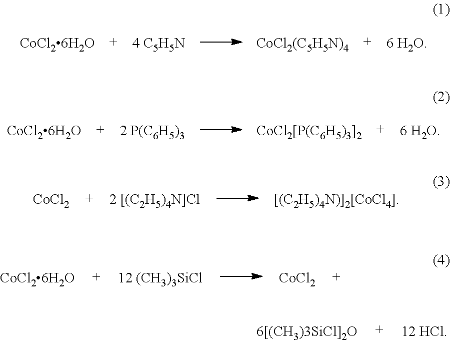

In some aspects, the modified silica gel composition can include iron (Fe) chloride, for example FeCl₃ on silica gel powder, iron (II) tetrasulphophthalocyanine adsorbed on silica gel modified with 1,10-phenanthroline or 3-n-propylpyridinium chloride.

In some aspects, the modified silica gel compositions can be regenerated. For example, the used modified silica gel composition can be sublimed under vacuum at a temperature of 20° C. to 400° C., or 20° C., 50° C., 100° C., 125° C., 150° C., 175° C., 200° C., 225° C., 250° C., 275° C., 300° C., 325° C., 350° C., 375° C., 400° C., or any range or value there between.

Waste plastic pyrolysis oil can be obtained from commercial sources. Nonlimiting examples of commercial sources include Enrestec, Inc (Taiwan), Beston Group Co. (China), Henan Dong Environmental Technology Inc. Co. (China), new Hope Energy (USA), Agile Process Chemicals (India). The waste plastic pyrolysis oil can have a boiling temperature of 20° C. to 500° C. (e.g., 20° C. to 500° C., 40° C. to 450° C., 50° C. to 400° C., 55° C. to 300° C. or any range or value there between). The waste plastic pyrolysis oil can have a molecular weight of 100 g/mol to 500 g/mol, or 100 g/mol, 150 g/mol, 200 g/mol, 250 g/mol, 300 g/mol, 350 g/mol, 400 g/mol, 450 g/mol, 500 g/mol or any value or range there between.

### B. System and Method of Purifying Waste Plastic Processing Pyoil

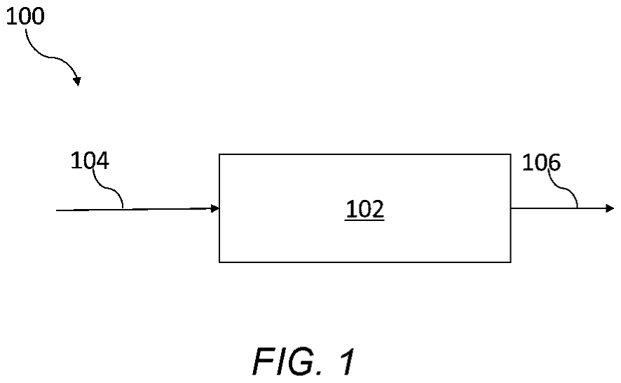

FIG. 1 depicts a schematic for a process for the purification of a waste plastic pyrolysis oil using a method of the present invention. System 100 can include purification unit 102. Waste plastic pyrolysis oil feed 104 can enter purification unit 102. The waste plastic pyrolysis oil can include pyoil derived from pyrolysis of mixed plastics. The pyoil can a boiling point range of 20° C. to 600° C. In embodiments of the invention, waste plastic pyrolysis oil feed 104 can directly flow through the purification unit 102 without other pretreatment (e.g., alkali rinsing, etc.). In embodiments of the invention, an adsorbent of purification unit 102 does not contain any added chemicals.

Purification unit 102 can be any known unit (e.g., packed column, pressure swing units, tank, and the like). For example, purification unit 102 can include a guard bed, a purification column, a fluidized bed, a stirring tank, or a combinations thereof. The adsorbent in purification unit 102 can be in a fixed bed and/or a fluidized bed, or be dispersed in a stirring tank. For example, purification unit 102 can include one or more absorbent beds filled with the modified silica gel composition of the present invention, and optionally other beds can include one or more types of absorbent. Other types of absorbent that can be used in combination with the modified silica gel composition of the present invention can include activated charcoal (carbon), a molecular sieve, a bleaching clay, an ionic resin, a cured eggshell powder, and combinations thereof. Non-limiting examples of the molecular sieve that can be used in combination with the modified silica gel composition of the present invention includes K₁₂[(AlO₂)12(SiO₂)₁₂]·nH₂O, Na₁₂[(AlO₂)₁₂(SiO₂)₁₂]·nH₂O, Ca_{4,5}[(AlO₂)₁₂(SiO₂)₁₂]·nH₂O, Na₈₆[(AlO₂)₈₆(SiO₂)₁₀₆]·nH₂O, or combinations thereof. The molecular sieve can have a pore size of 3 to 10 Å and all ranges and values there between including ranges of 3 to 4 Å, 4 to 5 Å, 5 to 6 Å, 6 to 7 Å, 7 to 8 Å, 8 to 9 Å, and 9 to 10 Å. The molecular sieve can be in a form of granules, flakes, beads, powder, or combinations thereof. When activated charcoal is used in combination with the modified silica gel composition, the activated charcoal can have a pore size in a range of 1 to 100 Å, a surface area of 10 to 8000 m²/g, or a combination thereof.

Contacting conditions for purifying the waste plastic pyrolysis oil can include temperature and/or pressure. A contacting temperature can range from 10 to 100° C. and all ranges and values there between including ranges of 10 to 20° C., 20 to 30° C., 30 to 40° C., 40 to 50° C., 50 to 60° C., 60 to 70° C., 70 to 80° C., 80 to 90° C., and 90 to 100° C. A contacting pressure can range from 0.01 MPa to 1 MPa or 0.01 MPa, 0.05 MPa, 0.1 MPa, 0.25 MPa, 0.5 MPa, 0.75 MPa, 1 MPa or all ranges and values there between. When an absorbent bed is employed, contacting conditions can include a weight hourly space velocity of 0.1 to 10 hr−1 and all ranges and values there between including ranges of 0.1 to 0.5 hr−1, 0.5 to 1 hr−1, 1 to 2 hr⁻¹, 2 to 4 hr⁻¹, 4 to 6 hr⁻¹, 6 to 8 hr⁻¹, and 8 to 10 hr⁻¹.

In some embodiments, purification unit 102 can be a tank/reactor equipped with a stirring apparatus. Waste plastic pyrolysis oil and the modified silica gel composition and optional other adsorbents can be dispersed in the stirring tank and be mixed for 1 minute to 10 hours and all ranges and values there between including 1 to 10 minutes, 10 to 30 minutes, 30 minutes to 1 hour, 1 to 2 hour, 2 to 3 hour, 3 to 4 hour, 4 to 5 hour, 5 to 6 hour, 6 to 7 hour, 7 to 8 hour, 8 to 9 hour, and 9 to 10 hour.

In purification unit 102, the waste plastic pyrolysis oil feed 104 can contact the modified silica gel composition of the present invention to produce a purified waste plastic pyrolysis oil 106. Purified waste plastic pyrolysis oil 106 can exit absorption unit 102 and be transported, stored, processed in other units, or a combination thereof. For example, adsorbent unit 102 can be positioned upstream of hydrotreating unit and/or cracking unit. Purified waste plastic pyrolysis oil 106 can include at least 50% by weight, 60 wt. %, 70 wt. %, 80 wt. %, 90 wt. %, 99 wt. % or any range or value there between less siloxane as compared to the same waste plastic pyrolysis oil composition that has not been processed or treated in the purification unit 102. A total organic nitrogen-containing compound content in purified waste plastic pyrolysis oil 106 can be at least 50% by weight, 60 wt. %, 70 wt. %, 80 wt. %, 90 wt. %, 99 wt. % or any range or value there between, less than the total nitrogen-containing compound content of the same waste plastic pyrolysis oil composition that has not been processed or treated in the purification unit 102. An oxygen-containing compound content in purified waste plastic pyrolysis oil 106 can be at least 50% by weight, 60 wt. %, 70 wt. %, 80 wt. %, 90 wt. %, 99 wt. % or any range or value there between, less than the oxygen-containing compound of the same waste plastic pyrolysis oil composition that has not been processed or treated in the purification unit 102. Purified waste plastic pyrolysis oil 106 can include at least 50% by weight, 60 wt. %, 70 wt. %, 80 wt. %, 90 wt. %, 99 wt. % or any range or value there between less chloride-containing as compared to the same waste plastic pyrolysis oil composition that has not been processed or treated in the purification unit 102. In some embodiments, a total amount of siloxanes, total organic nitrogen-containing compounds, oxygen-containing compounds, chloride-containing compounds can be at least 50% by weight, 60 wt. %, 70 wt. %, 80 wt. %, 90 wt. %, 99 wt. % or any range or value there between less than the total amount of siloxanes, total organic nitrogen-containing compounds, oxygen-containing compounds, chloride-containing compounds in the same waste plastic pyrolysis oil composition that has not been processed or treated in the purification unit 102. Purified waste plastic pyrolysis oil 106 can have a reduce density or a lighter color than the waste plastic pyrolysis oil feed 104 prior to contact with the modified silica gel composition of the present invention.

According to embodiments of the invention, system 100 can include an adsorbent regeneration unit configured to regenerate adsorbent (saturated or partially saturated) from purification unit 102 to remove the gum and/or gum precursors and produce regenerated adsorbent. As an alternative or in addition to an adsorbent regeneration unit, the absorbent (saturated or partially saturated) can be regenerated in purification unit 102 when the purification unit is inactive. In embodiments of the invention, at least a portion of saturated or partially saturated adsorbent of purification unit 102 can be discarded without regeneration. Regeneration can include heating the saturated or saturated adsorbent (thermal regeneration), vacuum and thermal regeneration, rinsing with strong acid or strong basic solution, and/or rinsing with polar organic solvent (e.g., tetrahydrofuran (THF).

As part of the disclosure of the present invention, specific examples are included below. The examples are for illustrative purposes only and are not intended to limit the invention. Those of ordinary skill in the art will readily recognize parameters that can be changed or modified to yield essentially the same results.

### Example 1

(Treating Pyoil with Modified Silica Gel Composition and Comparative Absorbents)

General Method. CoCl₂ modified silica gel granulates/powder of the present invention, comparative adsorbents of activated charcoal and molecular sieves (2 g each) were added to the waste plastic pyrolysis oil (pyoil, 10 mL each). Each sample was kept for a certain time and tested for changes in color, siloxane content, chloride content, oxygen content, nitrogen content. Si— and Cl— contents were measured by X-ray fluorescence (XRF), Si-speciation and total Si contents were also confirmed by NMR. Total organic nitrogen content was measured by isocratic gas chromatography with a chemiluminescence detector (GC-NCD) system. Measurement of oxygenate compositions and paraffins, isoparaffins, olefins, and naphtha (PIONA) compositions were assessed by comprehensive two-dimensional gas chromatography (GC×GC). The GC×GC-FID instrument setup consisted of Agilent GC with JEOL-TOF MS system fitted with a cryogenic thermal loop modulator ZX-1. Agilent Chemstation software was used for data acquisition and GCImage software was used for data analysis and visualization.

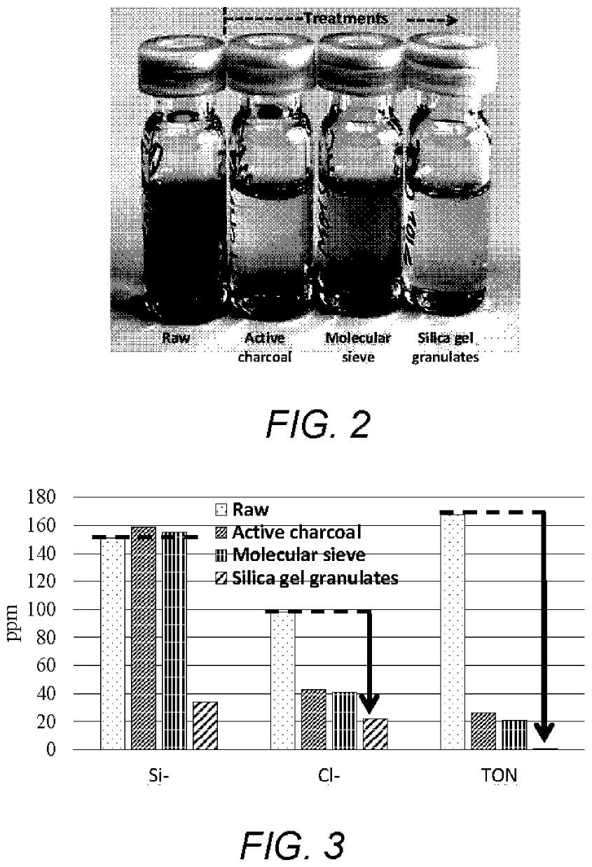

Results: Comparative reduction of Si—Cl—, O—, N-impurities by different absorbents. As shown in FIG. 2, compared to untreated pyoil, the active charcoal, molecular sieve and silica gel treated pyoil samples exhibited lighter color. Chemical analysis based of XRF, Total organic nitrogen (TON) (FIG. 3) revealed a significant reduction of Cl—, as well total organic nitrogen (TON) particularly for these absorbents. However, silica gel exceptionally reduced Si— along with Cl— and TON.

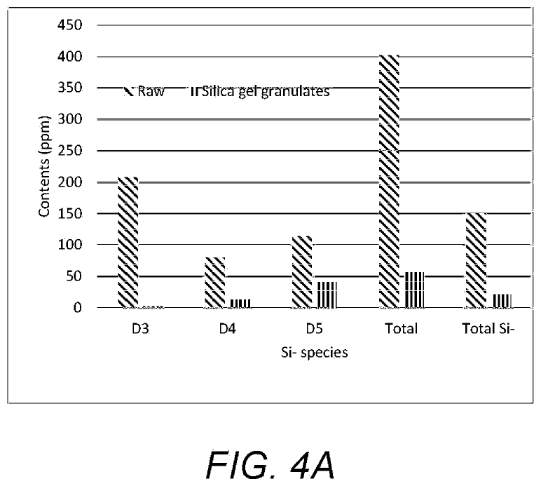

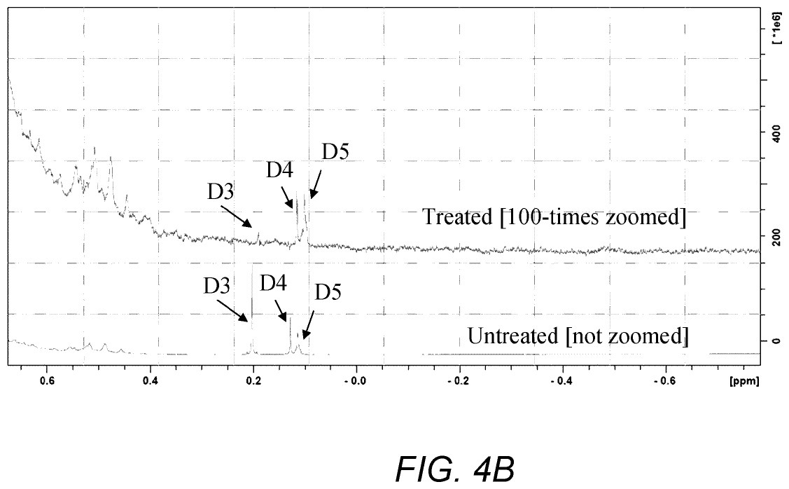

In-depth 1H-NMR based analysis of Si-species shown in FIGS. 4A and 4B, it was determined that cyclic siloxanes (peaks D3 (hexamethylcyclotrisiloxane), D4 (octamethylcyclotetrasiloxane), D5 (decamethylcyclopentasiloxane), which were highly abundant in raw pyoil were significantly removed by silica gel treatment. These results are consistent with the XRF based Si-measurements shown in FIG. 2. Si-removal efficiency was 77 wt. % as determined by XRF, whereas 1H-NMR indicated 86 wt. % removal.

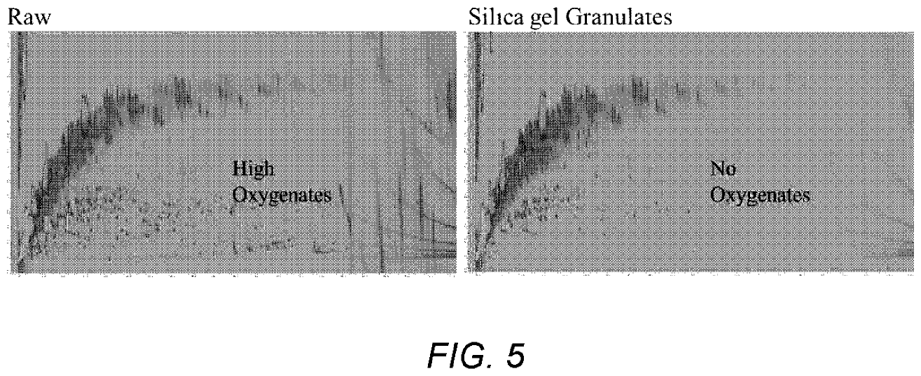

Comprehensive GC (GC×GC) based detailed heteroatom speciation shown in FIG. 5, confirmed the elimination of oxygenates from the pyoil after treatment with the modified silica gel composition of the present invention.

### Example 2

(Treating Pyoil with Different Modified Silica Gel Compositions of the Present Invention.)

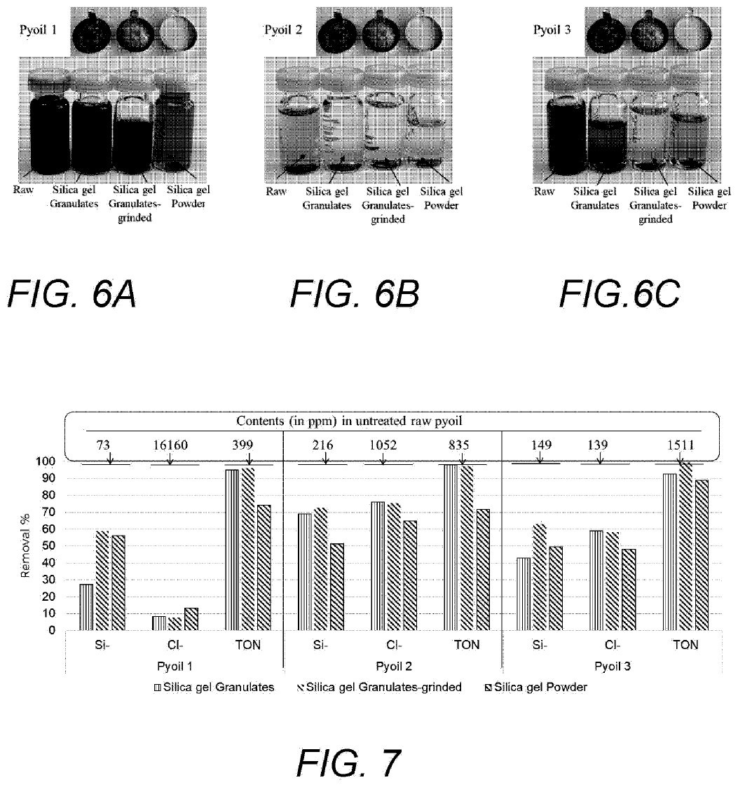

To understand the efficacy of different silica gels, three types of silica gels were investigated including cobalt chloride modified silica gel granulates, grinded silica gel granulates, and silica gel powder generally used for chromatographic purpose using the procedure of Example 1 for the removal of siloxanes, Cl—, and TON. Three different pyoils with different sources and compositions were also considered. Visual observation (FIG. 6) clearly revealed that all the silica gel tested exhibited lighter color indicating the removal of heteroatom containing compounds. The pyoils had a boiling range of 40° C. to 450° C. and molecular weight of 100 g/mol to 200 g/mol.

Chemical analysis based on XRF for Si— & Cl— and TON shown in FIG. 7 revealed that all the types of silicates tested significantly removed the contents of Si—, Cl—, and TON. Results also indicated that the grinded cobalt chloride modified silica gel performed slightly better compared to granule, probably due to increased surface area and wider pore availability which increase rate of diffusion. However, for the heavily contaminated sample-1, removal of certain groups particularly the Cl— is shown to be lower in % removal but is actually higher in term of adsorbent loading as shown in Table 1. Moreover, contents of different classes of impurities showed competitive behavior. Or said another way when diverse groups of contaminants were present, the groups competed with each other, and influenced the adsorbent loading of each other.

TABLE 1

| | Pyoil 1 | Pyoil 2 | Pyoil 3 |
|---|---|---|---|
| mg Cl/g ads | | | |
| CoCl₂ silica gel granulates | 5.468 | 3.2 | 0.328 |
| CoCl₂ silica gel powder | 4.968 | 3.172 | 0.324 |
| Silica with iron complex | n.a. | 2.9 | n.a. |
| Silica gel | 11.429 | 3.637 | 0.357 |
| mg Si/g ads | | | |
| CoCl₂ silica gel granulates | 0.08 | 0.596 | 0.256 |
| CoCl₂ silica gel powder | 0.172 | 0.628 | 0.376 |
| Silica gel | 0.219 | 0.592 | 0.395 |
| mg N/g ads | | | |
| CoCl₂ silica gel granulates | 1.516 | 3.272 | 5.592 |
| CoCl₂ silica gel powder | 1.536 | 3.26 | 6.012 |
| Silica with iron complex | n.a. | 23 | n.a |
| Silica gel | 1.579 | 3.189 | 7.162 |

### Example 3

### (Analysis of Modified Silica Gel Compositions of the Present Invention.

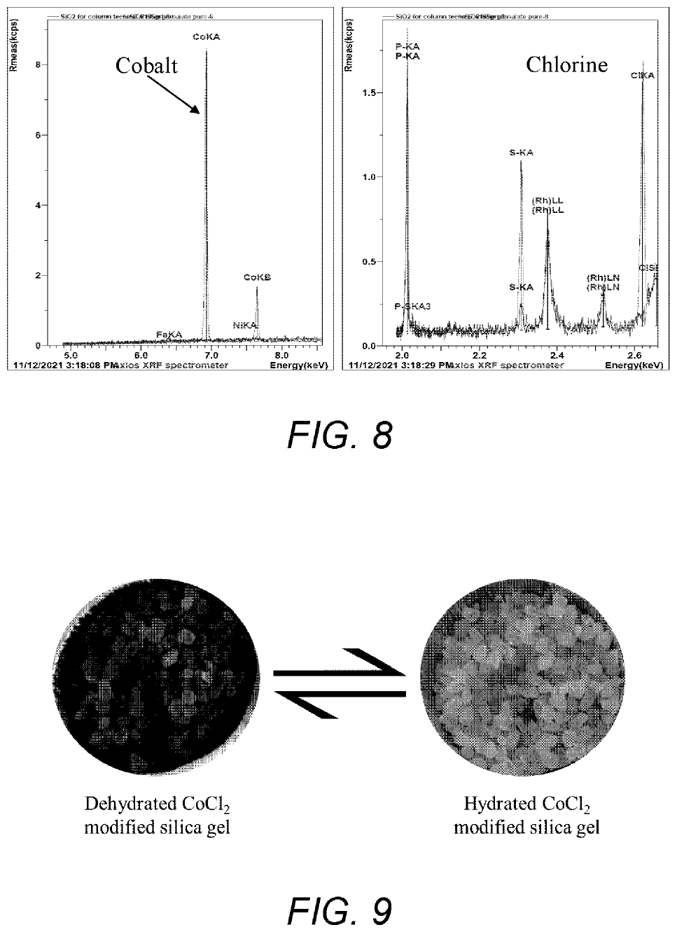

XRF based elemental analysis of different silica gels used revealed about 1% cobalt chloride in modified silica gel, but not in regular silica gel as shown in Table 2 and FIG. 8. Dehydrated CoCl₂ is blue in color, whereas hydrated cobalt chloride is pink in color, easily distinguishable and are reversible as shown in FIG. 9 by heating the hydrated CoCl₂ silica gel.

TABLE 2

| | CoCl₂ modified silica | Silica gel for column |
|---|---|---|
| | gel granulate | chromatography |
| | (mg/kg) | (mg/kg) |
| Compton | 1.19 | 1.19 |
| Si | 99% | 99.7% |
| Cl | 0.2 | Not detected |
| Co | 0.5 | Not detected |
| CoCl₂ | 0.8 | Not detected |

1. A process to reduce siloxanes in a waste plastic pyrolysis oil composition, the process comprising contacting the waste plastic pyrolysis oil composition with a modified silica gel composition under conditions sufficient to produce a purified waste plastic pyrolysis oil composition having at least 50% by weight less siloxanes, as compared to the waste plastic pyrolysis oil composition that was not contacted with the modified silica gel composition, wherein the modified silica gel composition comprises cobalt or iron.

2. The process of claim 1, wherein the modified silica gel composition comprises silica gel particles having a pore diameter of 0.01 mm to 5.0 mm, a pore size of 1.5 nm to 7 nm, or a combination thereof.

3. The process of claim 1, wherein the modified silica gel composition comprises silica gel granulates having a pore size of 1.5 nm to 5 nm, a pore diameter of 0.5 mm to 5 mm, or a combination thereof.

4. The process of claim 1, wherein the modified silica gel composition comprises silica gel powder granulates having a pore size of 5 nm to 7 nm, a pore diameter of 0.03 mm to 0.08 mm, or a combination thereof.

5. The process of claim 1, wherein the modified silica gel composition is ground.

6. The process of claim 1, wherein contacting conditions comprise a temperature of 10° C. to 100° C., a pressure of 0.101 MPa to 1 MPa, and/or a contact rate of 0.1 bed volume per hour (BV/h) to 5 BV/h, or any combination thereof.

7. The process of claim 1, wherein the modified silica gel composition comprises unmodified silica gel.

8. The process of claim 1, wherein the pyrolysis oil further comprises oxygen-containing compounds, and contact with the modified silica gel composition lowers the oxygen-containing compounds by at least 50 wt. % as compared to the waste plastic pyrolysis oil composition that was not contacted with the modified silica gel composition.

9. The process of claim 1, wherein the pyrolysis oil further comprises organic nitrogen-containing compounds and contact with the modified silica gel composition lowers the total organic nitrogen-containing compounds by at least 50 wt. %, at least 80 wt. %, at least 90 wt. % as compared to the waste plastic pyrolysis oil composition that was not contacted with the modified silica gel composition.

10. The process of claim 1, wherein the pyrolysis oil further comprises chloride containing compounds, and contact with the modified silica gel composition lowers the chlorides by at least 50 wt. %, at least 60 wt. % as compared to the waste plastic pyrolysis oil composition that was not contacted with the modified silica gel composition, wherein the chloride compounds comprise inorganic chloride compounds and organic chloride compounds.

11. The process of claim 1, wherein the pyrolysis oil further comprises oxygen-, organic nitrogen-, and/or chloride-containing compounds, and contact with the modified silica gel composition lowers the total amount of oxygen-containing compounds, organic nitrogen-containing compounds, and/or chloride-containing compounds by at least 50 wt. % as compared to the waste plastic pyrolysis oil composition that was not contacted with the modified silica gel composition.

12. The process of claim 1, wherein the weight ratio of the modified silica gel composition to the pyrolysis oil is 0.005 to 1.

13. The process of claim 1, further comprising regenerating the modified silica gel composition.

14. The process of claim 1, wherein the modified silica gel composition is in a dehydrated form.

15. The process of claim 1, wherein the modified silica gel composition is CoCl₂ silica.

16. The process of claim 1, wherein the purified waste plastic pyrolysis oil composition has at least 60% by weight less siloxanes.

17. The process of claim 16, wherein the siloxanes comprise acyclic siloxanes or cyclic siloxanes or a combination thereof.
